(19) United States
(12) Patent Application Publication
(10) Pub. No.: US 2026/0141322 A1
(43) Pub. Date: May 21, 2026

(54) SYSTEMS AND METHODS FOR WATER DAMAGE CLAIMS TRIAGE PORTAL WITH COMPUTER VISION

(71) Applicant: State Farm Mutual Automobile Insurance Company, Bloomington, IL (US)

(72) Inventor: Jacob BRAUN, Oviedo, FL (US)

(73) Assignee: State Farm Mutual Automobile Insurance Company, Bloomington, IL (US)

(21) Appl. No.: 18/952,297

(22) Filed: Nov. 19, 2024

(51) Int. Cl. G06Q 10/0631; G06Q 40/08

(52) U.S. Cl. CPC G06Q 10/063112; G06Q 40/08

(57) ABSTRACT

A method including receiving text image data corresponding to a claim instance from a user device. Inputting the text and image data into one or more trained machine-learning models to determine a text vector and an image vector corresponding to the text and image data. Inputting the text the image vectors into the one or more machine-learning models to determine one or more claim ratings corresponding to the claim instance. Receiving claims representative user data corresponding to one or more claims representative users from one or more data stores, wherein the claims representative user data includes a claims representative user identifier, a claims representative user availability, and a claims representative user skill level. Analyzing the claims representative user data and the one or more claim ratings to determine the best fit claims representative user. Transmitting the claim instance to a user device corresponding to the best fit claims representative user.

### TECHNICAL FIELD

Various embodiments of the present disclosure relate generally to systems and methods for training and utilizing artificial intelligence for classifying and prioritizing insurance claims instances.

### BACKGROUND

The home insurance claim process may be long and resource intensive. A user may initiate an insurance claim by contacting (e.g., phone call) their insurance carrier. The insurance carrier may then provide a representative to schedule an inspection to determine the breadth of the potential damage. The insurance carrier may then select another representative to provide additional support during the submission of the insurance claim. Another representative may be selected to further assist in the repair process to oversee repairs. At this point, upon initiating an insurance claim, the user may interact with, or be assigned to, more than one representative during the entirety of the insurance claims process. As a result, a need exists to quickly and efficiently analyze insurance claim information to properly assign a claims representative that best fits the needs of the user and the insurance claim.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for classifying insurance claims instances. More specifically, the disclosure may disclose methods and systems for training and utilizing artificial intelligence for classifying and prioritizing insurance claims instances.

In some aspects, the techniques described herein relate to a computer-implemented method for determining a best fit claims representative user, the computer-implemented method including. The method may further include receiving, by one or more processors, text data and image data corresponding to a claim instance from a user device. The method may further include inputting, by the one or more processors, the text data into one or more trained machine-learning models to determine a text vector corresponding to the text data. The method may further include inputting, by the one or more processors, the image data into the one or more trained machine-learning models to determine an image vector corresponding to the image data. The method may further include inputting, by the one or more processors, the text vector and the image vector into the one or more machine-learning models to determine one or more claim ratings corresponding to the claim instance. The method may further include receiving, by the one or more processors, claims representative user data corresponding to one or more claims representative users from one or more data stores, wherein the claims representative user data includes a claims representative user identifier, a claims representative user availability, and a claims representative user skill level. The method may further include analyzing, by the one or more processors, the claims representative user data and the one or more claim ratings to determine the best fit claims representative user. The method may further include based on the analyzing, transmitting, by the one or more processors, the claim instance to a user device corresponding to the best fit claims representative user.

In some aspects, the techniques described herein relate to a system for determining a best fit claims representative user, the system including: a memory storing instructions, one or more machine-learning models trained to determine the best fit claims representative user, a processor operatively connected to the memory and configured to execute instructions to perform: receiving, by one or more processors, text data and image data corresponding to a claim instance from a user device. The system may further include inputting, by the one or more processors, the text data into one or more trained machine-learning models to determine a text vector corresponding to the text data. The system may further include inputting, by the one or more processors, the image data into the one or more trained machine-learning models to determine an image vector corresponding to the image data. The system may further include inputting, by the one or more processors, the text vector and the image vector into the one or more machine-learning models to determine one or more claim ratings corresponding to the claim instance. The system may further include receiving, by the one or more processors, claims representative user data corresponding to one or more claims representative users from one or more data stores, wherein the claims representative user data includes a claims representative user identifier, a claims representative user availability, and a claims representative user skill level. The system may further include analyzing, by the one or more processors, the claims representative user data and the one or more claim ratings to determine the best fit claims representative user. The system may further include based on the analyzing, transmitting, by the one or more processors, the claim instance to a user device corresponding to the best fit claims representative user.

In some aspects, the techniques described herein relate to a non-transitory computer readable medium configured to store processor readable instructions, wherein when executed by a processor, the instructions perform operations including: receiving, by one or more processors, text data and image data corresponding to a claim instance from a user device. The instructions may further include inputting, by the one or more processors, the text data into one or more trained machine-learning models to determine a text vector corresponding to the text data. The instructions may further include inputting, by the one or more processors, the image data into the one or more trained machine-learning models to determine an image vector corresponding to the image data. The instructions may further include inputting, by the one or more processors, the text vector and the image vector into the one or more machine-learning models to determine one or more claim ratings corresponding to the claim instance. The instructions may further include receiving, by the one or more processors, claims representative user data corresponding to one or more claims representative users from one or more data stores, wherein the claims representative user data includes a claims representative user identifier, a claims representative user availability, and a claims representative user skill level. The instructions may further include analyzing, by the one or more processors, the claims representative user data and the one or more claim ratings to determine a best fit claims representative user. The instructions may further include based on the analyzing, transmitting, by the one or more processors, the claim instance to a user device corresponding to the best fit claims representative user.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary networked computing environment that may be utilized with techniques presented herein, according to one or more embodiments.

FIG. 2 depicts a flowchart of an exemplary method for utilizing a machine-learning model to determine a best fit claims representative user, according to one or more embodiments.

FIG. 3 depicts a flowchart of an exemplary method for utilizing a machine-learning model to update a best fit claims representative user, according to one or more embodiments.

FIG. 4 depicts a flowchart of another exemplary method for utilizing a machine-learning model to determine a best fit claims representative user, according to one or more embodiments.

FIG. 5 depicts a flowchart of an exemplary method for training a machine-learning model to determine how to route each claim insurance instance to an appropriate claims representative, according to one or more embodiments.

FIG. 6 depicts an exemplary computer system that may execute techniques presented herein, according to one or more embodiments.

### DETAILED DESCRIPTION OF EMBODIMENTS

According to certain aspects of the disclosure, systems and methods for training and utilizing artificial intelligence for classifying and prioritizing insurance claims instances are disclosed.

The home insurance claim process may be long and resource intensive. A user may initiate an insurance claim by contacting (e.g., phone call) their insurance carrier. The insurance carrier may then provide a representative to schedule an inspection to determine the breadth of the potential damage. The insurance carrier may then select another representative to provide additional support during the submission of the insurance claim. Another representative may be selected to further assist in the repair process to oversee repairs. At this point, upon initiating an insurance claim, the user may interact with, or be assigned to, more than one representative during the entirety of the insurance claims process. As a result, a need exists to quickly and efficiently analyze insurance claim information to properly assign a claims representative that best fits the needs of the user and the insurance claim.

To streamline this process, machine-learning and claims triage may be employed to enhance the efficiency of the insurance claims process. A system using machine-learning may determine claim information based on the information received from the user via text communication (e.g., SMS messaging, chat, email, etc.) and/or image data (e.g., photo data, video data, etc.). The machine-learning models may further determine.

The claimed systems and methods may utilize text and/or image data to determine additional information relating to an insurance claim (e.g., location, severity, type, etc.). One or more machine-learning models may analyze the text and/or image data to determine a claim instance rating, in order to describe the severity and/or type of submitted claim. In addition, the claimed systems and methods may determine an appropriate claims representative based on unique information relating to each claims representative (e.g., experience level, licenses, spoken languages, etc.). The claimed systems and methods may determine the best fit claims representative based on comparing the claim instance rating and the claims representative information.

The claimed systems and methods may increase the efficiency of the insurance claims process by utilizing machine-learning models to gather information and determine relationships between the claims instance and the claims representative to decrease the claim’s process length and needed resources.

As will be described in more detail below, in various embodiments, systems and methods are described for determining a best fit claims representative user. The systems and methods may include receiving, by one or more processors, text data and image data corresponding to a claim instance from a user device. The systems and methods may further include inputting, by the one or more processors, the text data into one or more trained machine-learning models to determine a text vector corresponding to the text data. The systems and methods may further include inputting, by the one or more processors, the image data into the one or more trained machine-learning models to determine an image vector corresponding to the image data. The systems and methods may further include inputting, by the one or more processors, the text vector and the image vector into the one or more machine-learning models to determine one or more claim ratings corresponding to the claim instance. The systems and methods may further include receiving, by the one or more processors, claims representative user data corresponding to one or more claims representative users from one or more data stores, wherein the claims representative user data includes a claims representative user identifier, a claims representative user availability, and a claims representative user skill level. The systems and methods may further include analyzing, by the one or more processors, the claims representative user data and the one or more claim ratings to determine the best fit claims representative user. The systems and methods may further include based on the analyzing, transmitting, by the one or more processors, the claim instance to a user device corresponding to the best fit claims representative user.

### Exemplary Environment

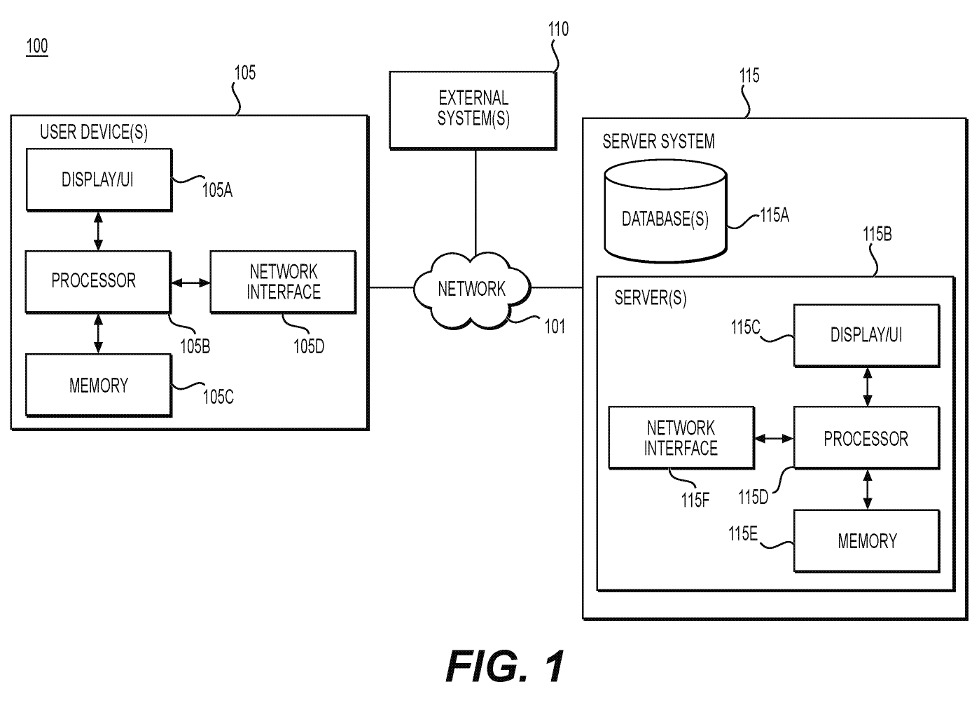

FIG. 1 depicts an exemplary environment 100 that may be utilized with techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user, e.g., a user associated with one or more of generating, training, or tuning a machine-learning model to determine how to route each claim instance (e.g., claim insurance instance) to an appropriate claims representative.

In some embodiments, the components of the environment 100 are associated with a common entity. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, and/or use a machine-learning model to determine how to route each claim insurance instance to an appropriate claims representative, among other activities.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various natural language instruction tasks. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may generate, store, train, or use a machine-learning model, configured to determine how to route each claim insurance instance to an appropriate claims representative. The server system 115 may include a machine-learning model and/or instructions associated with the machine-learning model, e.g., instructions for generating a machine-learning model, training the machine-learning model, using the machine-learning model, etc. The server system 115 may include instructions for processing natural language email instructions, e.g., based on the output of the machine-learning model, and/or operating the display 115C to output an action, e.g., as adjusted based on the machine-learning model. The server system 115 may include training data, e.g., a training text data, image data, claims representative user data, one or more labels, and/or one or more rules.

In some embodiments, a system or device other than the server system 115 is used to generate and/or train the machine-learning model. For example, such a system may include instructions for generating the machine-learning model, the training data and ground truth, and/or instructions for training the machine-learning model. A resulting trained machine-learning model may then be provided to the server system 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between the text data, image data, claims representative user data dataset, labels, and rules, such that the trained machine-learning model is configured to determine how to route each claim insurance instance to an appropriate claims representative based on the learned associations.

In various embodiments, the variables of a machine-learning model may be interrelated in any suitable arrangement in order to generate the output. For example, the machine-learning model may include one or more convolutional neural network (“CNN”) configured to determine contextual information relating to a claims instance, and may include further architecture, e.g., a connected layer, neural network, etc., configured to determine a relationship between the identified features in order to determine contextual information.

In various embodiments, the variables of a machine-learning model may be interrelated in any suitable arrangement in order to generate the output. For example, the machine-learning model may include one or more recurrent neural network (“RNN”) configured to determine images across a series of time, and may include further architecture, e.g., a connected layer, neural network, etc., configured to determine a relationship between the identified features in order to determine potential damage over the period of time.

Further aspects of the machine-learning model and/or how it may be utilized to process natural language queries in further detail in the method below. In the following methods, various acts may be described as performed or executed by a component from FIG. 1, such as the server system 115, the user device 105, or components thereof. However, it should be understood that in various embodiments, various components of the environment 100 discussed below may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

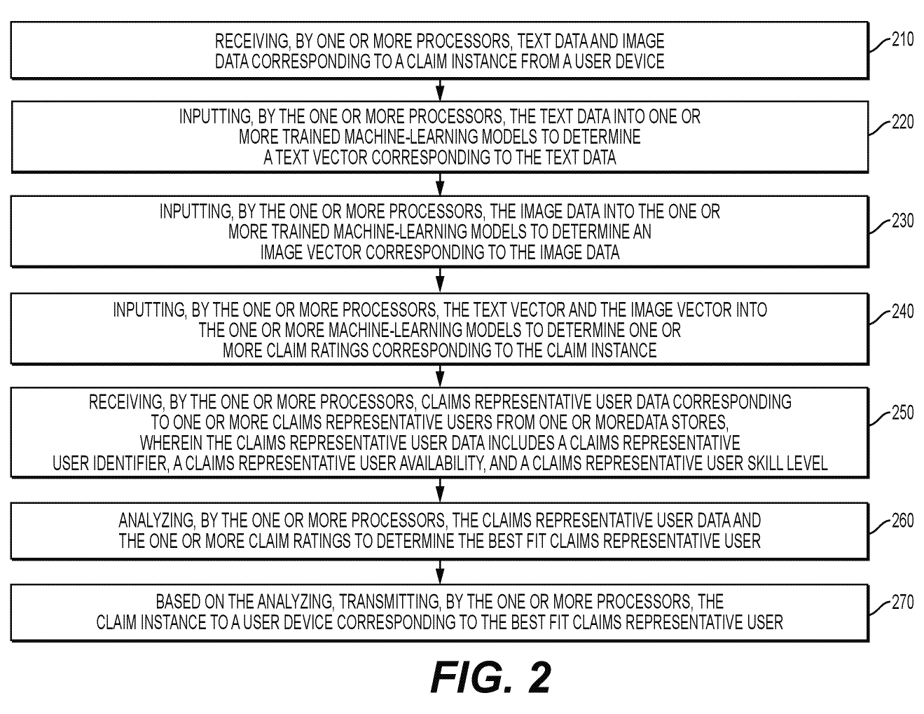

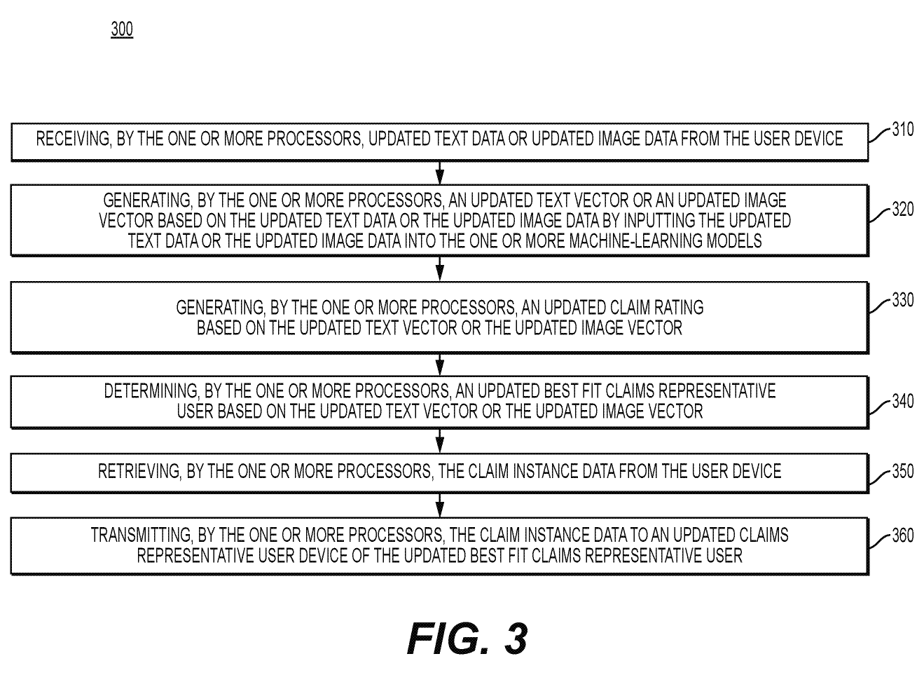

In general, any process or operation discussed in this disclosure that is understood to be computer-implementable, such as the process illustrated in FIGS. 2 and 3, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples below, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

### Exemplary Flowchart for Determining a Best Fit Claims Representative User

FIG. 2 depicts an exemplary method 200 for determining a best fit claims representative user, according to one or more embodiments. Notably, method 200 may be performed by one or more processors of a server that is in communication with a user device (e.g., user device 105), an external system (e.g., external system 110), or the like. However, it should be noted that he method may be performed by any one or more of the server, one or more user devices, one or more external systems, and/or other systems.

The method may include receiving, by one or more processors, text data and image data corresponding to a claim instance from a user device (e.g., user device 105) (Step 210). The text data may include one or more text strings, one or more character strings, or the like. The text data may correspond to a user’s description of water damage that occurred on the user’s property. The at least one image data may include an image, photo data, or video data, or the like. The image data may correspond to one or more images of water damage that occurred on the user’s property. The claim instance may correspond to an insurance claim that corresponds to the water damage that occurred on the user’s property. The claim instance may include data that describes the water damage, such as a location of the user’s property, a location of where the water damage occurred at the user’s property, a date that the water damage began, data describing the cause of the water damage, the user’s name, data corresponding to the user’s contact information, a unique identifier that corresponds to the user’s insurance policy, and the like.

In some embodiments, a user may input the text data and/or the image data into the user device to initiate an insurance claim process. For example, a user may initiate the claim process by sending a message via the user device (e.g., user device 105) to the claim system (e.g., server system 115). A chat system may receive the message and transmit the message to the claim system (e.g., an insurance company). The message may include information pertaining to the location of damage, type of damage, description of damage or the like. In addition, the user may capture an image of damage within the home to be included (e.g., as image data) when initiating the claim. A camera (e.g., of the user device) may capture the image, and the user device may upload and/or attach the image to the message discussed above. In another example, the system may receive the text data and the image data via different messaging systems (e.g., email and SMS messaging) of the claim system (e.g., insurance company).

The method may include inputting, by the one or more processors, the text data into one or more trained machine-learning models to determine a text vector corresponding to the text data (Step 220). For example, a machine-learning model (e.g., utilizing a CNN) may receive the text data from the system and determine a text vector based on the text data. The one or more machine-learning models may have been previously trained to determine contextual information from the text data (e.g., location, damage type, severity, etc.). For example, the text data may be segmented and/or parsed to determine one or more context items. Context items may include, but are not limited to, location information of the water damage, damage information (e.g., type, severity, etc.) of the water damage, a duration of the water damage (e.g., how long the water damage has been going on), and/or whether the water damage is a repeat occurrence. The text data may be received by a server system (e.g., server system 115) from a user device (e.g., user device 105) using a messaging system (e.g., SMS messaging, chat messaging) in a first format and the machine-learning model may convert the text data from the first format to a second format when generating the text vector. The first format may include an informational format (e.g., text and/or character strings) based on manually inputted and/or automatically generated data (e.g., user text input). The second format may include a machine-readable format that may be provided as input to one or more machine-learning models for determining a text vector. Converting the first format to the second format may include adding known associations between different characteristics. The characteristics may correspond to one or more of the context items, where the associations may correspond to one or more relationships between the context items. For example, the text data may include information relating to a location of the damage and a length of time. The machine-learning model may determine one or more associations, where damage in the bathroom for a period of 24-hours may indicate that the water damage is severe. In comparison to the first format, such associations may be more easily analyzed by the machine-learning models. The second format may include, for example, a JSON file, XML file, or the like.

The method may include inputting, by the one or more processors, the image data into the one or more trained machine-learning models to determine an image vector corresponding to the image data (Step 230). For example, the system may input the image data into a machine-learning model (e.g., utilizing RNN) to determine an image vector. For example, the RNN may determine the image vector by processing a series of images received over a period of time. The one or more machine-learning models may have been previously trained to determine contextual information from the image data (e.g., location, damage type, severity, etc.). For example, the system may segment and/or parse the image data to determine one or more context items. The system may receive the image data in a third format, where the machine-learning model may convert the image data from the third format to a fourth format when generating the image vector. The third format may include an informational format (e.g., captured image or photograph from a user device) based on manually inputted and/or automatically generated data (e.g., user image input). The fourth format may include a machine-readable format that may be provided as an input to one or more machine-learning models for determining an image vector. A server system (e.g., server system 115) or an external system (e.g., external system 110) may convert the third format to the fourth format by adding known associations between different characteristics. For example, the image data may include information relating to a location and size of the damage. The machine-learning model may determine one or more associations, such as that the water damage started from a leak in an above bathroom. These associations may be more easily analyzed by the machine-learning models in comparison to the third format. The fourth format may include, for example, a JSON file, XML file, or the like.

The method include inputting, by the one or more processors, the text vector and the image vector into the one or more machine-learning models to determine one or more claim ratings corresponding to the claim instance (Step 240). For example, the system may input both the text vector and the image vector into a multi-modal machine-learning model. A multi-modal machine-learning model may be configured to combine both the text vector and the image vector to determine further associations. Using the associations determined above, the multi-modal machine-learning model may further determine that the water damage may be critical and may need specialized services due to the size of the watermark on the ceiling, the damage may had spread to the support structure and may need additional teams (e.g., mold, structural, etc.) to repair the damage. The one or more claim ratings may provide additional details corresponding to the claims instance. For example, the claim ratings may include a numeric or alphanumeric rating based on one or more factors. The factors may include, but are not limited to, a damage type, a severity, and/or a location of the water damage. The alphanumeric claim rating may identify the type of damage using a letter association (e.g., “W” for water) and a numeric value relating to the severity (e.g., scale 0-10). The claim ratings may further provide one or more numeric values to identify contextual information about the claim as described above. The multi-modal machine-learning model may utilize two or more machine-learning models in parallel (e.g., at the same time or near the same time) or in series (e.g., one after another) to determine a set of information (e.g., vector) relating to two or more data streams (e.g., text and/or image data).

For example, the machine-learning model may have previously converted the text vector and the image vector from the informational format to a machine-readable format. In addition, the multi-modal machine-learning module may have previously converted the combined text vector and the image vector from a machine-readable format to the same or a different machine-readable format to include the claim ratings.

The method may include receiving, by the one or more processors, claims representative user data corresponding to one or more claims representative users from one or more data stores, wherein the claims representative user data includes a claims representative user identifier, a claims representative user availability, and a claims representative user skill level (Step 250). A claims representative user may correspond to a user who reviews and processes claims that are received by the claims system. For example, the claims representative user data may include a set of characteristics that may assist in determining a user skill level, including, but not limited to, a user identifier, a user availability, a user skill level, local and/or state licenses, spoken languages, educational background and/or the like. The claims representative user identifier may correspond to a unique identifier for each of the claims representative users. The claims representative user availability may correspond to the current workload and availability of the claims representative user. The claims representative user skill level may correspond to local and/or state licenses, spoken languages, education background, and/or the like.

The method may include analyzing, by the one or more processors, the claims representative user data and the one or more claim ratings to determine the best fit claims representative user (Step 260). For example, the environment (e.g., environment 100) may perform a triage of each claim instance by comparing the claims representative user data and the one or more claim ratings to determine the most appropriate claims representative user at the time of receiving the claim instance from the user device. The one or more trained machine-learning models may perform the claims triage, as discussed above, with respect to each of the claims representative users prior to determining the most appropriate claims representative.

The method may further include determining, by the one or more processors, a claims representative user score based on the claims representative user data. For example, the claims representative user score may be determined using the claims representative user data, where the claims representative user data, including California state licenses with a specialization in water damage, may receive a higher score than a claims representative user with claims representative user data that includes a California state license with a specialization in tornado damage. The claims representative user score may be in the form of numeric, text, alphanumeric, vector, and/or the like. The system may use the claims representative user score to further identify the appropriate claims representative user for each claim instance. For example, each claims representative may be assigned a claims representative user score range that may correspond to one or more claims ratings that may fall within the assigned claims representative user score range. The claims representative user score may utilize any format that may be recognizable by the one or more machine-learning models. The one or more machine-learning models may further utilize the determined claims representative user data, claims representative user score, and/or the claim ratings to determine known associations between each of the items, as described above. The system may use the known associations to better determine the best fit claims representative user.

Additionally, the method may further include ranking, by one or more processors, the claims representative user score for each of the one or more claims representative users based on the one or more claim ratings corresponding to the claim instance. For example, the system may rank the claims representative user score according to each claim instance currently stored in the system (e.g., of an insurance company).

Each claim instance may have been previously given the claim rating to provide additional details as to the claim instance (e.g., damage type, severity, etc.). The system may compare the claim rating to the claims representative user score to determine a rank of each claim instance and a corresponding claims representative to appropriately match each claim instance with a claims representative. For example, each claims representative may be assigned a claims representative user score range that may correspond to one or more claims ratings that may fall within the assigned claims representative user score range. Each claims representative user may receive a claims representative user score with a range that indicates the type(s) of damage they may specialize in, regardless of the severity (e.g., using alphanumeric assignment to indicate the claims representative specializes in water damage). Each claim instance, which has a respective claim rating (e.g., alphanumeric), may fall within the assigned claims representative user score range that includes water damage type claim instances because the claim rating indicates water damage.

The method may further include utilizing, by the one or more processors, the one or more machine-learning models to analyze the image vector, the text vector, and the at least one claim rating to determine one or more confidence scores for each of the one or more claim ratings. For example, the one or more machine-learning models may receive the text vector, image vector, and/or claim ratings to output a confidence score. The confidence scores may include information relating to the accuracy of each claim instance and the corresponding claim ratings. For example, the confidence score may include a percentage value from 0 to 100 (e.g., 92%), zero being the least accurate to 100 being the most accurate, identifying an accuracy for each of the received data values. The method may further include analyzing, by the one or more processors, the one or more confidence scores for each of the one or more claim ratings. For example, the one or more confidence scores may be determined from one or more machine-learning models using trained data and/or manual data. The one or more confidence scores may provide additional quality control in determining the best fit claims representative for each claim instance. For example, the system may select a claim rating with a higher confidence score over a claim rating with a lower confidence score, which may be used as part of the determination of the best fit claims representative (Step 260). Claim ratings with lower confidence scores (e.g., below a threshold value) may need additional information (see FIG. 3).

The method may further include, based on the analyzing (e.g., Step 260), transmitting, by the one or more processors, the claim instance to a user device corresponding to the best fit claims representative user (Step 270). For example, upon determining the best fit claims representative, the claim instance and corresponding information (e.g., text data and image data) may be provided, among other things, to a user device (e.g., user device 105) of the selected claims representative. The claims representative may then proceed to contact the user (e.g., via an electronic communication) who initiated the claim instance, in order to proceed with processing the claim instance on behalf of the insurance company.

Although FIG. 2 shows example blocks of exemplary method 200, in some implementations, the exemplary method 300 may include additional blocks, fewer blocks, different blocks, or differently arranged blocks than those depicted in FIG. 2. Additionally, or alternatively, two or more of the blocks of the exemplary method 200 may be performed in parallel.

### Exemplary Flowchart for Updating a Best Fit Claims Representative User

FIG. 3 depicts a flowchart of an exemplary method for utilizing a machine-learning model to update a best fit claims representative user, according to one or more embodiments. Notably, the process depicted in method 300 may be performed by one or more processors of a server that is in communication with a user device (e.g., user device 105), an external system (e.g., external system 110), or the like. However, it should be noted that he method may be performed by any one or more of the server, one or more user devices, one or more external systems, and/or other systems.

The method may include receiving, by the one or more processors, updated text data or updated image data from the user device (Step 310). As similarly discussed with respect to step 210 in FIG. 2, the updated text data may include one or more text strings, one or more character strings, or the like, and the updated image data may include additional images, photo data, video data, or the like. For example, a user may update the initial claim instance by providing additional information by sending a message via a user device (e.g., user device 105) to the system. The message may be sent through a chat system (e.g., associated with the insurance company), the message may be part of a continuation of a message thread already in use by the user, or the message may be part of a new message thread that is associated with the original claim instance. A reference number (or something similar) may act as an association to the claim. The message may include additional information pertaining to the location of damage, type of damage, description of damage or the like. In addition, the user may capture additional images of damage (e.g., over time) within the home to update the claim instance. The image may be captured via a camera of the user device and uploaded and/or attached to the message that is discussed above. In another example, the text data and the image data may be received through different messaging systems (e.g., email and SMS messaging) of the system (e.g., insurance company). In a further example, the updated information may include at least one of updated text data or updated image data. For example, after initiating the claim instance in method 200, as described in connection with FIG. 2, the user may capture additional images to provide additional details regarding the severity of the damage. The additional images may provide sufficient detail so that no further text data may be needed.

The method may include generating, by the one or more processors, an updated text vector or an updated image vector based on the updated text data or the updated image data by inputting the updated text data or the updated image data into the one or more machine-learning models (Step 320). For example, the updated text data and/or the updated image data may be input into one or more machine-learning model (e.g., utilizing CNN and/or RNN) to determine an updated text vector or an updated image vector. The one or more machine-learning models may be trained to determine contextual information from the updated text data and updated image data (e.g., location, damage type, severity, etc.). For example, the updated text data may be segmented and/or parsed to determine one or more context items. The context items may include, but are not limited to, location information of the water damage, damage information (e.g., type, severity, etc.), a duration of the water damage, and/or whether the water damage is a repeat occurrence. The updated data may be received by a server system (e.g., server system 115) for a user device (e.g., user device 105) using a messaging system (e.g., SMS messaging) in a first format and the machine-learning model may convert the updated text data from the first format to a second format when generating the updated text vector. The first format may include an informational format (e.g., text and/or character strings) based on manually inputted and/or automatically generated data (e.g., user text input). The second format may include a machine readable format that may be provided as an input to one or more machine-learning models for determining the updated text vector. Converting the first format to the second format may include adding known associations between different characteristics. For example, the text data may include information relating to a location of the damage and a length of time. These associations may be more easily analyzed by the machine-learning models in comparison to the first format. The second format may include, for example, a JSON file, XML file, or the like. Similarly, the updated image data may be segmented and/or parsed to determine one or more context items. The updated image data may be received in a third format and the machine-learning model may convert the updated image data from the third format to a fourth format when generating the updated image vector. The third format may include an informational format (e.g., captured image(s) or photograph(s)) based on manually inputted and/or automatically generated data (e.g., user image input). The fourth format may include a machine readable format that may be provided as an input to one or more machine-learning models for determining the updated image vector. A server system or external system may convert the third format to the fourth format including adding known associations between different characteristics. For example, the image data may include information relating to a location and size of the damage. The machine-learning model may determine one or more associations, such as, damage came from a leak in an above bathroom. These associations may be more easily analyzed by the machine-learning models in comparison to the third format. The fourth format may include, for example, a JSON file, XML file, or the like.

The method may include generating, by the one or more processors, an updated claim rating based on the updated text vector or the updated image vector (Step 330). For example, both the updated text vector and the updated image vector may be input into the multi-modal machine-learning model, as discussed above.

The method may include determining, by the one or more processors, an updated best fit claims representative user based on the updated text vector or the updated image vector (Step 340). Step 340 may perform some or all of the step 250 and step 260 as described in FIG. 2 above. For example, the claims representative user data may be updated based on one or more of the claims representative users receiving new or updated information regarding the claims representative user’s license, certificate, training, availability, or the like. Step 250 of method 200 may be updated to accurately determine the claims representative user score, as described in step 260 of method 200 in FIG. 2. A further example may include, updating the claim rating corresponding to the claim instance. The updated text data and/or the updated image data may provide additional details to further define the claim instance (e.g., severity). The claim rating may be updated based on the received updated information (e.g., text and/or image data) to accurately identify the claim instance. A determination of the best fit claims representative may be different from the initial determination in step 260 of method 200 of FIG. 2. In a further example, when the confidence score of the claim ratings of a claim instance falls below a threshold, as described with respect to step 260, the system may request additional information from the user. The user may then include additional information as described in step 310, as described above. Upon determining an updated best fit claims representative user, method 300 may proceed to step 350.

The method may include retrieving, by the one or more processors, the claim instance data from the user device (Step 350). For example, additional information from the user may have been inputted into the user device to further define the claim instance (e.g., update text data or updated image data). This information may be used to repeat some or all of the steps of method 300 as described above. In another example, information between the user and the best fit claims representative user (e.g., text messages, images, emails, etc.) may be gathered to determine the step at which the current claim instance is in the claim process.

The method may include transmitting, by the one or more processors, a notification to the user device, wherein the notification indicates the retrieval of the claim instance data from the user device. For example, when the user inputs updated text data or updated image data, the system may send a notification to the user indicating that the information has been received and may be processed to update the claim instance. In another example, the user may receive a notification of the selection of the updated claims representative user to take over the claim instance.

The method may include transmitting, by the one or more processors, the claim instance data to an updated claims representative user device of the updated best fit claims representative user (Step 360). For example, upon determining the updated best fit claims representative, the updated claim instance and corresponding information (e.g., updated text data and/or updated image data) may be provided, among other things, to a user device (e.g., user device 105) of the selected claims representative. The claims representative may then proceed to contact the user who initiated the claim instance to proceed on behalf of the insurance company. In some instances, the same claims representative may be the same claims representative as originally selected in method 200 of FIG. 2. In other instances, a new or different claims representative may be selected to proceed with the claim instance.

Although FIG. 3 shows example blocks of exemplary method 300, in some implementations, the exemplary method 300 may include additional blocks, fewer blocks, different blocks, or differently arranged blocks than those depicted in FIG. 3. Additionally, or alternatively, two or more of the blocks of the exemplary method 300 may be performed in parallel.

### Exemplary Flowchart for Determining a Best Fit Claims Representative User

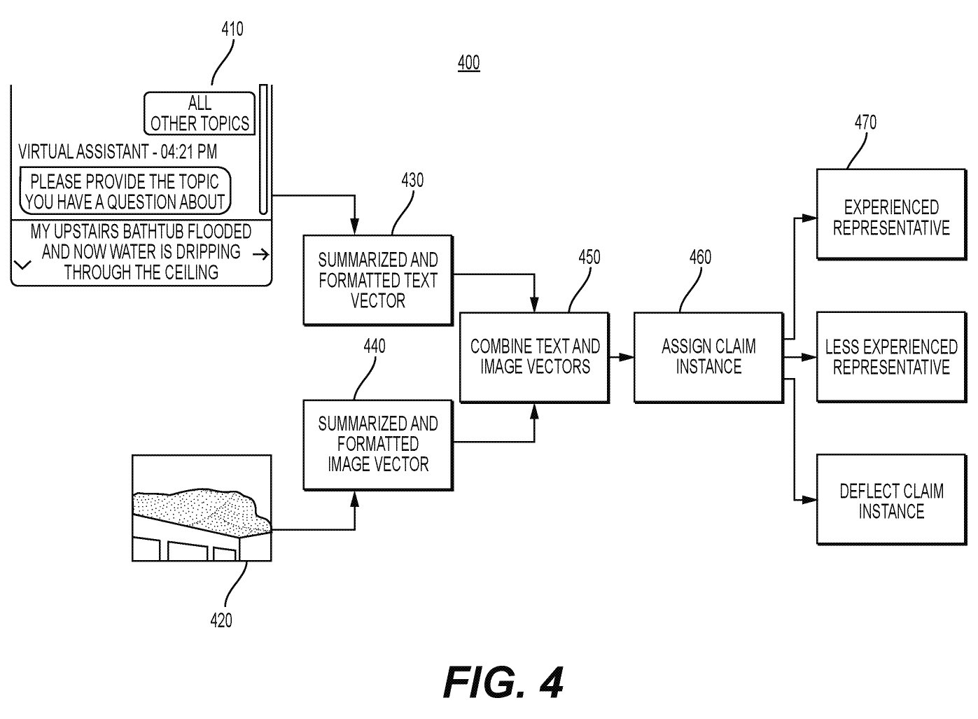

FIG. 4 depicts a flowchart of another exemplary method for utilizing a machine-learning model to determine a best fit claims representative user, according to one or more embodiments. Notably, the process depicted in method 400 may be performed by one or more processors of a server that is in communication with a user device (e.g., user device 105), an external system (e.g., external system 110), or the like. However, it should be noted that the method may be performed by any one or more of the server, one or more user devices, one or more external systems, and/or other systems.

As similarly described in both step 210 and step 310 of FIGS. 2 and 3, respectively, the method may include inputting text data with respect to a claim instance (Step 410). For example, the user may initiate a claim instance through an insurance portal and input textual data (e.g., text characters and/or text strings) via SMS messaging.

As similarly described in step 220 and step 320 of FIGS. 2 and 3, respectively, the method may include determining and formatting a text vector (Step 430). For example, the text data may be input into a machine-learning model (e.g., utilizing CNN) to determine a text vector. The one or more machine-learning models may be trained to determine contextual information from the text data (e.g., location, damage type, severity, etc.). For example, the text data may be segmented and/or parsed to determine one or more context items. The text data may be received in a first format and the machine-learning model may convert the text data from the first format to a second format when generating the text vector. The first format may include an informational format based on manually inputted and/or automatically generated data (e.g., user text input). The second format may include a machine-readable format that may be provided as an input to one or more machine-learning models. Converting the first format to the second format may include adding known associations between different characteristics. These associations may be more easily analyzed by the machine-learning models in comparison to the first format. The second format may include, for example, a JSON file, XML file, or the like.

As similarly described in step 210 and step 310 of FIGS. 2 and 3, respectively, the method may include inputting image data with respect to a claim instance (Step 420). For example, the user may initiate a claim instance through an insurance portal and input image data (e.g., uploading images and/or videos) via SMS messaging.

As similarly described in step 230 and step 320 of FIGS. 2 and 3, respectively, the method may include determining and formatting an image vector (Step 440). For example, the image data may be input into a machine-learning model (e.g., utilizing RNN) to determine an image vector. For example, the RNN may determine the image vector by processing a series of images received over a period of time. The one or more machine-learning models may be trained to determine contextual information from the image data (e.g., location, damage type, severity, etc.). For example, the image data may be segmented and/or parsed to determine one or more context items. The image data may be received in a third format and the machine-learning model may convert the image data from the third format to a fourth format when generating the image vector. The third format may include an informational format based on manually inputted and/or automatically generated data (e.g., user image input). The fourth format may include a machine readable format that may be provided as an input to one or more machine-learning models. Converting the third format to the fourth format may include adding known associations between different characteristics. These associations may be more easily analyzed by the machine-learning models in comparison to the third format. The fourth format may include, for example, a JSON file, XML file, or the like.

The method may include combining the text vector and the image vector using one or more multi-modal machine-learning models (Step 450). For example, the multi-modal machine-learning model may utilize two or more machine-learning models in parallel (e.g., at the same time or near the same time) or in series (e.g., one after another) to determine a set of information (e.g., vector) relating to two or more data streams (e.g., text and/or image data). The text vector and the image vector may be received in the second and fourth formats, respectively, and the one or more machine-learning models may convert the text vector and the image vector from the second and fourth format to a fifth format. Converting the second and fourth format to the fifth format may include adding known associations between different characteristics. These associations may be more easily analyzed by the machine-learning models in comparison to the second and fourth format. The fifth format may include, for example, a JSON file, XML file, or the like.

The method may include assigning the claim instance to a best fit claims representative, as similarly described in steps 260 and 340 of FIGS. 2 and 3 respectively (Step 460 and Step 470). For example, the system may perform a triage by comparing the claim instance (from the received text data and/or image data) and claims representative user data to determine the most appropriate claims representative user at the time of the claim instance submission. The claim triage may be performed by one or more trained machine-learning models as discussed above. The triage process may determine whether the claim instance should be placed with an experienced representative, a less experienced representative, or deflect the claim instance. For example, deflecting a claim instance may include not assigning a claims representative to the claim instance until further information is received.

Although FIG. 4 shows example blocks of exemplary method 400, in some implementations, the exemplary method 400 may include additional blocks, fewer blocks, different blocks, or differently arranged blocks than those depicted in FIG. 4. Additionally, or alternatively, two or more of the blocks of the exemplary method 400 may be performed in parallel.

### Exemplary Machine-learning Techniques

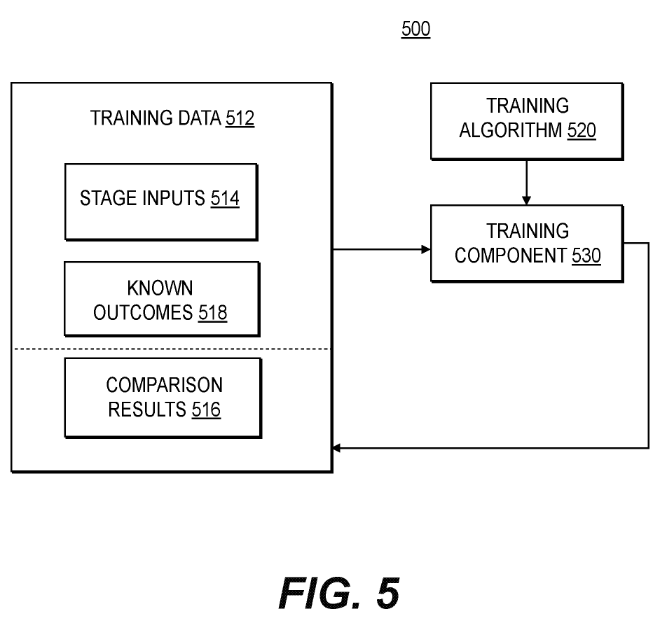

FIG. 5 depicts a flowchart of an exemplary method for training a machine-learning model to determine how to route each claim instance (e.g., water damage insurance claim) to an appropriate claims representative, according to one or more embodiments. One or more implementations disclosed herein include and/or may be implemented using a machine-learning model. For example, one or more devices (e.g., user device 105) of the environment 100 may be implemented using a machine-learning model and/or may be used to train the machine-learning model. A given machine-learning model may be trained using the data flow 500 of FIG. 5. Training data 512 may include one or more of stage inputs 514 and known outcomes 518 related to the machine-learning model to be trained. The stage inputs 514 may be from any applicable source including text, visual representations, data, values, comparisons, and stage outputs, e.g., one or more outputs from one or more actions or operations from FIGS. 2 to 4. The known outcomes 518 may be included for the machine-learning models generated based upon supervised or semi-supervised training. An unsupervised machine-learning model may not be trained using known outcomes 518. Known outcomes 518 may include known or desired outputs for future inputs similar to or in the same category as stage inputs 514 that do not have corresponding known outputs.

The training data 512 and a training algorithm 520, e.g., one or more of the modules implemented using the machine-learning model and/or may be used to train the machine-learning model, may be provided to a training component 530 that may apply the training data 512 to the training algorithm 520 to generate the machine-learning model. According to an implementation, the training component 530 may be provided comparison results 516 that compare a previous output of the corresponding machine-learning model to apply the previous result to re-train the machine-learning model. The comparison results 516 may be used by training component 530 to update the corresponding machine-learning model. The training algorithm 520 may utilize machine-learning networks and/or models including, but not limited to a deep learning network such as Deep Neural Networks (DNN), Convolutional Neural Networks (CNN), Fully Convolutional Networks (FCN), and Recurrent Neural Networks (RNN), probabilistic models such as Bayesian Networks and Graphical Models, classifiers such as K-Nearest Neighbors, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In general, any process or operation discussed in this disclosure is understood to be computer-implementable, such as the processes illustrated in FIGS. 2-4 may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

### Exemplary Computing Environment

In general, any process or operation discussed in this disclosure is understood to be computer-implementable, such as the processes illustrated in FIGS. 2 to 4 and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

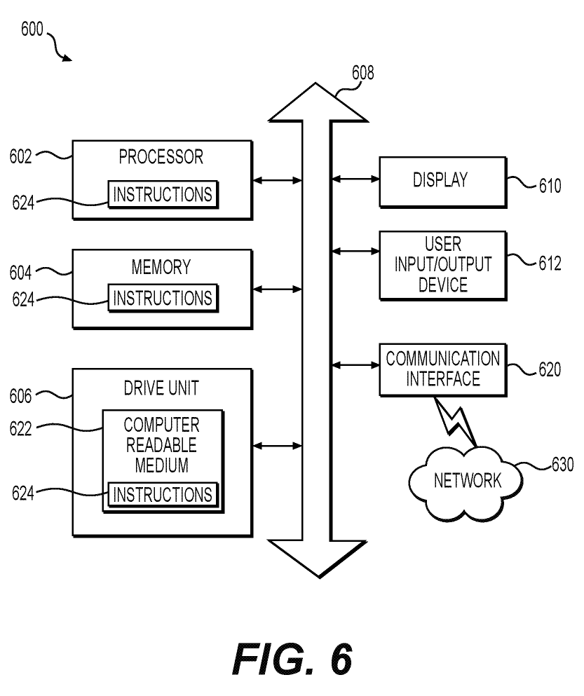

FIG. 6 depicts an exemplary computer system that may execute techniques presented herein, according to one or more embodiments. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 600 may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 600 may be implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. The processor 602 may be a component in a variety of systems. For example, the processor 602 may be part of a standard personal computer or a workstation. The processor 602 may be one or more processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via bus 608. The memory 604 may be a main memory, a static memory, or a dynamic memory. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 may include a cache or random-access memory for the processor 602. In alternative implementations, the memory 604 is separate from the processor 602, such as a cache memory of a processor, the system memory, or other memory.

The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the processor 602 executing the instructions stored in the memory 604. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 600 may further include a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 may act as an interface for the user to see the functioning of the processor 602, or specifically as an interface with the software stored in the memory 604 or in the drive unit 606.

Additionally or alternatively, the computer system 600 may include an input/output device 612 configured to allow a user to interact with any of the components of the computer system 600. The input/output device 612 may be a number pad, a keyboard, or a cursor control device, such as a mouse, or a joystick, touch screen display, remote control, or any other device operative to interact with the computer system 600.

The computer system 600 may also or alternatively include drive unit 606 implemented as a disk or optical drive. The drive unit 606 may include a computer-readable medium 622 in which one or more sets of instructions 624, e.g., software, can be embedded. Further, instructions 624 may embody one or more of the methods or logic as described herein. The instructions 624 may reside completely or partially within the memory 604 and/or within the processor 602 during execution by the computer system 600. The memory 604 and the processor 602 also may include computer-readable media as discussed above.

In some systems, computer-readable medium 622 includes the set of instructions 624 or receives and executes the set of instructions 624 responsive to a propagated signal so that a device connected to network 630 can communicate voice, video, audio, images, or any other data over the network 630. Further, the set of instructions 624 may be transmitted or received over the network 630 via communication port or interface 620, and/or using bus 608. The communication port or interface 620 may be a part of the processor 602 or may be a separate component. The communication port or interface 620 may be created in software or may be a physical connection in hardware.

The communication port or interface 620 may be configured to connect with a network 630, external media, the display 610, or any other components in computer system 600, or combinations thereof. The connection with the network 630 may be a physical connection, such as a wired Ethernet connection or may be established wirelessly as discussed below. Likewise, the additional connections with other components of the computer system 600 may be physical connections or may be established wirelessly. The network 630 may alternatively be directly connected to the bus 608.

While the computer-readable medium 622 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 622 may be non-transitory, and may be tangible.

The computer-readable medium 622 can include a solid-state memory such as a memory card or other package that houses one or more non-volatile read-only memories. The computer-readable medium 622 can be a random-access memory or other volatile re-writable memory. Additionally or alternatively, the computer-readable medium 622 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 600 may be connected to network 630. The network 630 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 630 may include wide area networks (WAN), such as the Internet, local area networks (LAN), campus area networks, metropolitan area networks, a direct connection such as through a Universal Serial Bus (USB) port, or any other networks that may allow for data communication.

The network 630 may be configured to couple one computing device to another computing device to enable communication of data between the devices. The network 630 may generally be enabled to employ any form of machine-readable media for communicating information from one device to another. The network 630 may include communication methods by which information may travel between computing devices.

The network 630 may be divided into sub-networks. The sub-networks may allow access to all of the other components connected thereto or the sub-networks may restrict access between the components. The network 630 may be regarded as a public or private network connection and may include, for example, a virtual private network or an encryption or other security mechanism employed over the public Internet, or the like.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for determining a best fit claims representative user, the computer-implemented method comprising:
receiving, by one or more processors, text data and image data corresponding to a claim instance from a user device;
inputting, by the one or more processors, the text data into one or more trained machine-learning models to determine a text vector corresponding to the text data;
inputting, by the one or more processors, the image data into the one or more trained machine-learning models to determine an image vector corresponding to the image data;
inputting, by the one or more processors, the text vector and the image vector into the one or more machine-learning models to determine one or more claim ratings corresponding to the claim instance;
receiving, by the one or more processors, claims representative user data corresponding to one or more claims representative users from one or more data stores, wherein the claims representative user data includes a claims representative user identifier, a claims representative user availability, and a claims representative user skill level;
analyzing, by the one or more processors, the claims representative user data and the one or more claim ratings to determine the best fit claims representative user; and
based on the analyzing, transmitting, by the one or more processors, the claim instance to a user device corresponding to the best fit claims representative user.

2. The computer-implemented method of claim 1, wherein the text data includes one or more text strings or one or more character strings, and wherein the image data includes an image, photo data, or video data.

3. The computer-implemented method of claim 1, wherein analyzing the claims representative user data further includes:
determining, by the one or more processors, a claims representative user score based on the claims representative user data.

4. The computer-implemented method of claim 3, further including:
ranking, by one or more processors, the claims representative user score for each of the one or more claims representative user based on the one or more claim ratings corresponding to the claim instance.

5. The computer-implemented method of claim 1, the computer-implemented method further comprising:
utilizing, by the one or more processors, the one or more machine-learning models to analyze the image vector, the text vector, and the one or more claim ratings to determine one or more confidence scores for each of the one or more claim ratings.

6. The computer-implemented method of claim 5, wherein analyzing, by the one or more processors, the claims representative user data and the one or more claim ratings to determine the best fit claims representative user includes:
analyzing, by the one or more processors, the one or more confidence scores for each of the one or more claim ratings.

7. The computer-implemented method of claim 1, further including:
receiving, by the one or more processors, updated text data or updated image data from the user device;
generating, by the one or more processors, an updated text vector or an updated image vector based on the updated text data or the updated image data by inputting the updated text data or the updated image data into the one or more machine-learning models;
generating, by the one or more processors, an updated claim rating based on the updated text vector or the updated image vector;
determining, by the one or more processors, an updated best fit claims representative user based on the updated text vector or the updated image vector;
retrieving, by the one or more processors, the claim instance data from the user device; and
transmitting, by the one or more processors, the claim instance data to an updated claims representative user device of the updated best fit claims representative user.

8. The computer-implemented method of claim 7, wherein retrieving the claim instance data from the user device includes:
transmitting, by the one or more processors, a notification to the user device, wherein the notification indicates the retrieval of the claim instance data from the user device.

9. A system for determining a best fit claims representative user, the system comprising:
a memory storing instructions;
one or more machine-learning models trained to determine the best fit claims representative user;
a processor operatively connected to the memory and configured to execute instructions to perform:
receiving, by one or more processors, text data and image data corresponding to a claim instance from a user device;
inputting, by the one or more processors, the text data into one or more trained machine-learning models to determine a text vector corresponding to the text data;
inputting, by the one or more processors, the image data into the one or more trained machine-learning models to determine an image vector corresponding to the image data;
inputting, by the one or more processors, the text vector and the image vector into the one or more machine-learning models to determine one or more claim ratings corresponding to the claim instance;
receiving, by the one or more processors, claims representative user data corresponding to one or more claims representative users from one or more data stores, wherein the claims representative user data includes a claims representative user identifier, a claims representative user availability, and a claims representative user skill level;
analyzing, by the one or more processors, the claims representative user data and the one or more claim ratings to determine the best fit claims representative user; and
based on the analyzing, transmitting, by the one or more processors, the claim instance to a user device corresponding to the best fit claims representative user.

10. The system of claim 9, wherein the text data includes one or more text strings or one or more character strings, and wherein the image data includes an image, photo data, or video data.

11. The system of claim 9, wherein analyzing the claims representative user data further includes:
determining, by the one or more processors, a claims representative user score based on the claims representative user data; and
ranking, by the one or more processors, the claims representative user score for each of the one or more claims representative user with respect to the one or more claim ratings corresponding to the claim instance.

12. The system of claim 9, further including:
utilizing, by the one or more processors, the one or more machine-learning models to analyze the image vector, the text vector, and the one or more claim ratings to determine one or more confidence score for each of the one or more claim ratings;
wherein analyzing, by the one or more processors, the claims representative user data and the one or more claim ratings to determine the best fit claims representative user includes analyzing the one or more confidence scores for each of the one or more claim ratings.

13. The system of claim 9, further including:
receiving, by the one or more processors, updated text data or updated image data;
generating, by the one or more processors, an updated text vector or an updated image vector based on the updated text data or the updated image data by inputting the updated text data or the updated image data into the one or more machine-learning models;
generating, by the one or more processors, an updated claim rating based on the updated text vector or the updated image vector;
determining, by the one or more processors, an updated best fit claims representative user based on the updated text vector or the updated image vector;
retrieving, by the one or more processors, the claim instance data from the user device; and
transmitting, by the one or more processors, the claim instance data to an updated claims representative user device of the updated best fit claims representative user.

14. The system of claim 13, wherein retrieving the claim instance data from the user device includes: transmitting, by the one or more processors, a notification to the user device, wherein the notification indicates the retrieval of the claim instance data from the user device.

15. A non-transitory computer readable medium configured to store processor readable instructions, wherein when executed by a processor, the instructions perform operations comprising:
receiving, by one or more processors, text data and image data corresponding to a claim instance from a user device;
inputting, by the one or more processors, the text data into one or more trained machine-learning models to determine a text vector corresponding to the text data;
inputting, by the one or more processors, the image data into the one or more trained machine-learning models to determine an image vector corresponding to the image data;
inputting, by the one or more processors, the text vector and the image vector into the one or more machine-learning models to determine one or more claim ratings corresponding to the claim instance;
receiving, by the one or more processors, claims representative user data corresponding to one or more claims representative users from one or more data stores, wherein the claims representative user data includes a claims representative user identifier, a claims representative user availability, and a claims representative user skill level;
analyzing, by the one or more processors, the claims representative user data and the one or more claim ratings to determine a best fit claims representative user; and
based on the analyzing, transmitting, by the one or more processors, the claim instance to a user device corresponding to the best fit claims representative user.

16. The non-transitory computer readable medium of claim 15, wherein the text data includes one or more text strings or one or more character strings, and wherein the image data includes an image, photo data, or video data.

17. The non-transitory computer readable medium of claim 15, wherein analyzing the claims representative user data further includes:
determining, by the one or more processors, a claims representative user score based on the claims representative user data; and
ranking, by one or more processors, the claims representative user score for each of the one or more claims representative user with respect to the one or more claim ratings corresponding to the claim instance.

18. The non-transitory computer readable medium of claim 15, further including:
utilizing, by the one or more processors, the one or more machine-learning models to analyze the image vector, the text vector, and the one or more claim ratings to determine one or more confidence score for each of the one or more claim ratings;
wherein analyzing, by the one or more processors, the claims representative user data and the one or more claim ratings to determine the best fit claims representative user includes analyzing the one or more confidence scores for each of the one or more claim ratings.

19. The non-transitory computer readable medium of claim 15, further including:
receiving, by the one or more processors, updated text data or updated image data;
generating, by the one or more processors, an updated text vector or an updated image vector based on the updated text data or the updated image data by inputting the updated text data or the updated image data into the one or more machine-learning models;
generating, by the one or more processors, an updated claim rating based on the updated text vector or the updated image vector;
determining, by the one or more processors, an updated best fit claims representative user based on the updated text vector or the updated image vector;
retrieving, by the one or more processors, the claim instance data from the user device; and
transmitting, by the one or more processors, the claim instance data to an updated claims representative user device of the updated best fit claims representative user.

20. The non-transitory computer readable medium of claim 19, wherein retrieving the claim instance data from the user device includes: transmitting, by the one or more processors, a notification to the user device, wherein the notification indicates the retrieval of the claim instance data from the user device.
